(19) United States
(12) Patent Application Publication
(10) Pub. No.: US 2023/0252107 A1
(43) Pub. Date: Aug. 10, 2023

(54) MANAGEMENT DEVICE, MANAGEMENT METHOD, AND STORAGE MEDIUM

(71) Applicant: Kabushiki Kaisha Toshiba, Tokyo (JP)

(72) Inventors: Toshinari HAMAMOTO, Kawasaki (JP); Masataka YAMADA, Shinagawa (JP); Toshiyuki KATOU, Yokohama (JP); Takahiro KOZUKA, Fuchu (JP)

(73) Assignee: Kabushiki Kaisha Toshiba, Tokyo (JP)

(21) Appl. No.: 17/897,394

(22) Filed: Aug. 29, 2022

(30) Foreign Application Priority Data
Feb. 8, 2022 (JP) 2022-017771

(51) Int. Cl. G06K 9/62; G06N 20/00

(52) U.S. Cl. CPC G06K 9/6262; G06N 20/00

(57) ABSTRACT

According to an embodiment, a management device includes a data processor, a data manager, and an evaluator. The data processor is configured to perform at least one preprocessing operation of creating a training dataset. The data manager is configured to perform a process of saving the created training dataset. The evaluator is configured to evaluate a model created using the created training dataset. The data manager is configured to temporarily save the created training dataset, and determine whether or not to permanently save the created training dataset on the basis of an evaluation result of the model by the evaluator.

### CROSS-REFERENCE TO RELATED APPLICATION

This application is based upon and claims the benefit of priority from Japanese Patent Application No. 2022-017771, filed Feb. 8, 2022; the entire contents of which are incorporated herein by reference.

### FIELD

Embodiments of the present invention relate to a management device, a management method, and a storage medium.

### BACKGROUND

A machine learning/artificial intelligence (AI) model is created by executing a learning algorithm using training data. When a model is developed and operated according to machine learning, a series of workflows such as preprocessing of raw data to be used as training data, feature extraction, model creation, and model verification are required. Such workflow concepts and methods are referred to as machine learning operations (MLOps) and are implemented using a machine learning pipeline.

The machine learning pipeline includes a plurality of components. The components implement some functions in developing and operating a model. For example, the component implements a function of creating a model. In such a machine learning pipeline, the model developer inputs necessary parameters, issues an execution instruction, and develops the model. The parameters are changed many times and the model is reconstructed such that a highly accurate model is developed. The model developer can select a model with high accuracy by comparing created models with each other.

### BRIEF DESCRIPTION OF THE DRAWINGS

FIG. 1 is a functional block diagram showing an example of a functional configuration of a management device 1 according to an embodiment.

FIG. 2 is a diagram showing an example of components constituting a machine learning pipeline (MLP) according to the embodiment.

FIG. 3 is a diagram showing an example of a data configuration of a training data storage 41 according to the embodiment.

FIG. 4 is a diagram showing an example of a data configuration of a model storage 42 according to the embodiment.

FIG. 5 is a diagram showing an example of a data configuration of a metadata storage 43 according to the embodiment.

FIG. 6 is a diagram showing an example of a data configuration of a source code storage 44 according to the embodiment.

FIG. 7 is a flowchart showing an example of a workflow of a version management process of the management device 1 according to the embodiment.

FIG. 8 is a flowchart showing an example of a workflow for a version management function addition process of the management device 1 according to the embodiment.

FIG. 9 is a sequence diagram for describing an operation when version management (an initial operation) is performed according to the embodiment.

FIG. 10 is a sequence diagram for describing an operation when version management (difference data addition) is performed according to the embodiment.

FIG. 11 is a sequence diagram for describing an operation when version management (difference data deletion) is performed according to the embodiment.

FIG. 12 is a sequence diagram for describing an operation when version management (comparison) is performed according to the embodiment.

FIG. 13 is a sequence diagram for describing an operation when version management (model management) is performed according to the embodiment.

FIG. 14 is a sequence diagram for describing an operation when version management (model evaluation) is performed according to the embodiment.

FIG. 15 is a sequence diagram for describing an operation when version management (version control function addition) is performed according to the embodiment.

### DETAILED DESCRIPTION

Hereinafter, a management device, a management method, and a storage medium according to embodiments will be described with reference to the drawings.

When the evaluation results for models created using the machine learning pipeline are compared, it may be confirmed what types of training data or parameters have been used in the model with high accuracy with respect to the evaluation results. A process of performing version management for such training data and parameters is known. This version management uses a method of saving training data (new data) used when another model is created while keeping training data (old training data) used when a certain model is created. That is, versions from the old version to the new version are managed in a state in which both the old data and the new data are kept.

In the data version management in the related art as described above, because a training dataset is managed individually every time a model is created and a redundant part is saved without being eliminated even if training data is redundant, this becomes a factor that puts pressure on a storage capacity. Also, it is not easy to compare model creation conditions because it is not possible to ascertain a difference between pieces of training data. Also, it is necessary for the model developer to provide a source code that describes processing content for implementing training data version management such that version management is performed separately from the machine learning pipeline, an implementation method differs according to a model developer, and a coding error and wasted time are caused. Also, if data preprocessing includes a plurality of steps, when the preprocessing in a certain step fails, the data preprocessing needs to be performed from the beginning and time for re-execution is required.

An objective of the present invention is to provide a management device, a management method, and a storage medium capable of implementing efficient training data version management.

According to an embodiment, a management device includes a data processor, a data manager, and an evaluator. The data processor is configured to perform at least one preprocessing operation of creating a training dataset. The data manager is configured to perform a process of saving the created training dataset. The evaluator is configured to evaluate a model created using the created training dataset. The data manager is configured to temporarily save the created training dataset, and determine whether or not to permanently save the created training dataset on the basis of an evaluation result of the model by the evaluator.

According to the embodiment, the management device manages a version of the training data used when a machine learning model is created. Also, the management device manages the created model, metadata indicating various types of information related to the model creation, a source code for creating each component constituting a machine learning pipeline, and the like.

### [Overall Configuration]

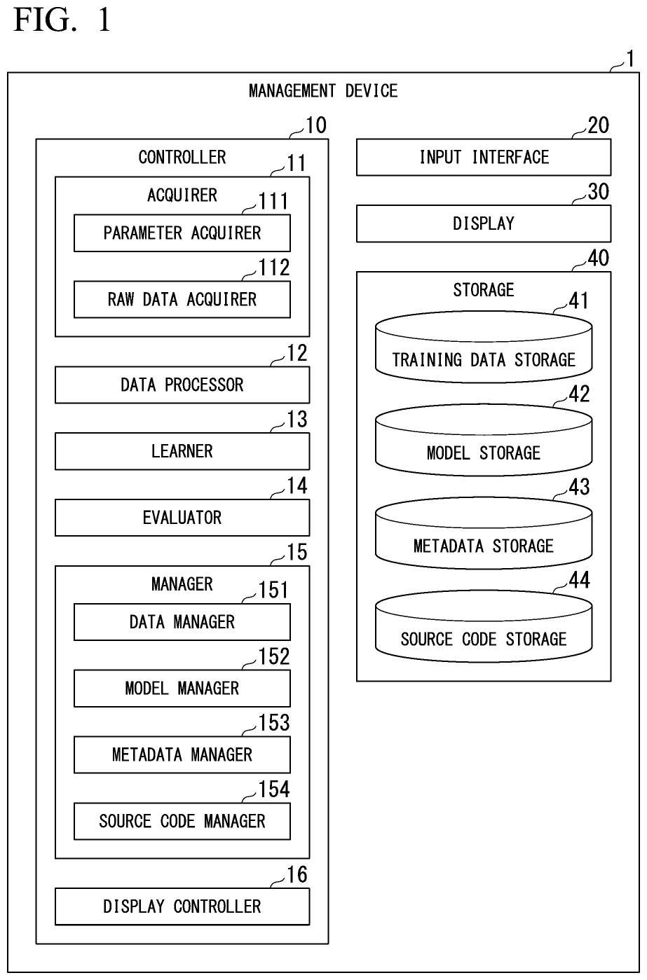

FIG. 1 is a functional block diagram showing an example of a functional configuration of the management device 1 according to the embodiment. The management device 1 includes, for example, a controller 10, an input interface 20, a display 30, and a storage 40. The controller 10 includes, for example, an acquirer 11, a data processor 12, a learner 13, an evaluator 14, a manager 15, and a display controller 16.

Each functional part of the controller 10 is implemented by a central processing unit (CPU) (a computer) executing a program. Also, some or all of the functional parts of the controller 10 may be implemented by hardware such as a large-scale integration (LSI) circuit, an application specific integrated circuit (ASIC), or a field-programmable gate array (FPGA) or may be implemented by software and hardware in cooperation. The program may be stored in advance in the storage 40 (a storage device including a non-transitory storage medium) or may be stored in a removable storage medium (the non-transitory storage medium) such as a DVD or a CD-ROM and installed when the storage medium is mounted in a drive device.

The acquirer 11 includes, for example, a parameter acquirer 111 and a raw data acquirer 112. For example, the parameter acquirer 111 acquires various types of parameter information input by a user (for example, a model developer) via the input interface 20. The parameter information includes, for example, reference destination information and parameters for acquiring data required when a model is created, authentication information and a uniform resource locator (URL) of a version management system such as Git required for data version management, and the like. Furthermore, the acquirer 11 may acquire parameter information from an external device (not shown) connected to the management device 1 by a network.

The raw data acquirer 112 acquires raw data stored in the storage 40 using the reference destination information for acquiring data acquired by the parameter acquirer 111. This raw data includes raw data for learning and raw data for evaluation.

The data processor 12 performs preprocessing on the raw data for learning acquired by the raw data acquirer 112. Preprocessing the raw data is performing some processing (editing, processing, merging, extraction, or the like) on the raw data. Preprocessing the raw data is arranging collected raw data for ease of learning and creating training data. The training data is data for which all preprocessing has been completed. That is, the data processor 12 performs at least one preprocessing operation of creating a training dataset.

The learner 13 creates a model using the training data (preprocessed data) created in the preprocessing of the data processor 12 and parameters acquired by the parameter acquirer 111. For example, the learner 13 creates a model based on machine learning using a method such as a neural network or a support vector machine (SVM).

The evaluator 14 evaluates the model created by the learner 13 using the evaluation data. The evaluator 14 acquires raw data for evaluation from the training data storage 41 using evaluation information of the model acquired by the parameter acquirer 111 and calculates an evaluation index such as accuracy or a confusion matrix using evaluation data obtained by preprocessing the raw data. The evaluator 14 determines the acceptance/non-acceptance of the created model on the basis of the calculated evaluation index. For example, the evaluator 14 compares a calculated correct answer rate with a threshold value predetermined by the model developer and determines acceptance/non-acceptance by determining whether or not the calculated correct answer rate exceeds the threshold value. That is, the evaluator 14 evaluates the model created using the created training dataset.

The manager 15 includes, for example, a data manager 151, a model manager 152, a metadata manager 153, and a source code manager 154. The data manager 151 manages the version of the training data in each process of the workflow. The data manager 151 is implemented by additionally implementing a component having a training data version management function in the function of the machine learning pipeline created in advance by the model developer. For example, the component is executed when a Git-specific URL and authentication information transferred as an input of the machine learning pipeline are given such that training data version management is performed.

That is, the data manager 151 performs a process of saving the created training dataset. The data manager 151 temporarily saves the created training dataset and determines whether or not to permanently save the created training dataset on the basis of a model evaluation result of the evaluator 14. The data manager 151 determines whether or not there is a difference between a training dataset newly created in a preprocessing operation of the data processor 12 and a saved preprocessed training dataset. At least one preprocessing operation includes first preprocessing and second preprocessing. The data processor 12 creates a second preprocessed dataset by performing the second preprocessing on a temporarily saved first preprocessed training dataset. The data manager 151 temporarily saves the second preprocessed dataset. The data manager 151 determines whether or not there is a difference between the first preprocessed dataset and the second preprocessed dataset. The data manager 151 temporarily saves the second preprocessed dataset when it is determined that there is a difference between the first preprocessed dataset and the second preprocessed dataset. The data manager 151 determines to permanently save the created training dataset when the model evaluation result is acceptable. The data manager 151 determines not to permanently save the created training dataset when the model evaluation result is unacceptable and discards the temporarily saved training dataset. The data manager 151 creates a branch for performing version management and temporarily saves the created training dataset in the branch. The data manager 151 temporarily saves the created training dataset every time each of a plurality of preprocessing operations is completed. The data manager 151 saves metadata related to a model training process.

The model manager 152 manages the version of the model created by the learner 13. The metadata manager 153 manages the metadata. The metadata is data indicating relationships between pieces of data such as models, training data, and parameters. The metadata manager 153 manages the metadata (hyperparameters and the like) used by the learner 13 for each model version when the model is created. The source code manager 154 has a function of managing the source code. The source code is a computer program that shows processing content of each component that constitutes the machine learning pipeline. For example, the source code is a text file that describes the processing content of a component having a model creation function in a programming language.

The display controller 16 causes the display 30 to display the evaluation result of the evaluator 14 and the like. Also, the display controller 16 causes the display 30 to display a graphical user interface (GUI) for receiving various types of inputs and instructions from the model developer.

The input interface 20 receives various types of input operations from the model developer and outputs an electrical signal indicating content of the received input operations to the controller 10. The input interface 20 is implemented by, for example, a keyboard, a mouse, a touch panel, or the like.

The display 30 displays various types of information. For example, the display 30 displays a GUI that receives various types of operations by the model developer and the like. The display 30 is, for example, a liquid crystal display, an organic electroluminescence (EL) display, a touch panel, or the like. Furthermore, the display 30 may be provided separately from the management device 1 and display various types of information by communicating with the management device 1. Also, when the display 30 is implemented by a touch panel, the display 30 may also have the above-described functions of the input interface 20.

The storage 40 is a storage device such as a hard disk drive (HDD), a random-access memory (RAM), or a flash memory. The storage 40 includes, for example, a training data storage 41, a model storage 42, a metadata storage 43, and a source code storage 44. The training data storage 41 stores preprocessed data, training data, evaluation data, and the like. The model storage 42 stores a model created by the learner 13. The metadata storage 43 stores metadata used for model creation. The source code storage 44 stores a source code.

### [Configuration of Machine Learning Pipeline]

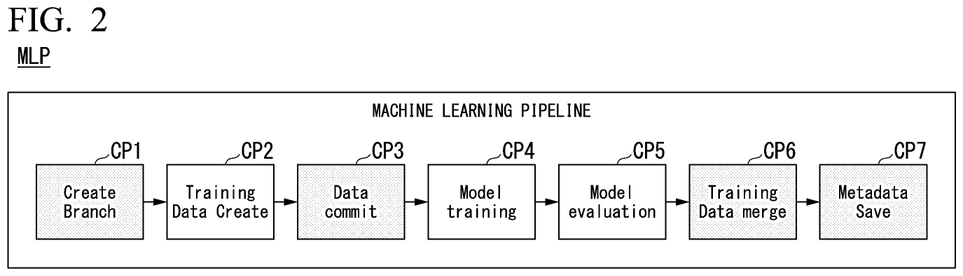

FIG. 2 is a diagram showing a list of components required to implement the workflow according to the embodiment with the machine learning pipeline (MLP) and an example of the execution order thereof. In the machine learning pipeline (MLP) shown in FIG. 2, a total of seven components CP1 to CP7 are defined to be executed in order.

The component CP1 has a function (Create Branch) of creating a branch. The component CP2 has a function (Training Data Create) of performing preprocessing to create training data. The component CP3 has a function (Data commit) of temporarily saving preprocessed data. The component CP4 has a function (Model training) of creating a model using the training data. The component CP5 has a function (Model evaluation) for evaluating the created model. The component CP6 has a function (Training Data merge) of permanently saving the training data. The component CP7 has a function (Metadata Save) of saving metadata. Furthermore, in the present embodiment, both temporary saving and permanent saving indicate that various types of data are physically stored in the storage 41. The temporary saving is temporarily (provisionally) storing data in the storage 41 before a final saving decision is made. The permanent saving is storing the data in the storage 41 (changing the temporarily saved data to a permanently saved state) after the final storage decision is made.

Among the components CP1 to CP7, the component CP1, the component CP3, the component CP6, and the component CP7 are components provided by the management device 1 such that version management is implemented. On the other hand, the component CP2, the component CP4, and the component CP5 are components prepared by the model developer himself/herself. The model developer can easily implement the function for version management using the management device 1. Furthermore, the machine learning pipeline (MLP) shown in FIG. 2 is an example and may include other components. For example, the number and execution order of the components prepared by the model developer himself/herself can be changed.

### [Data Configuration of Storage]

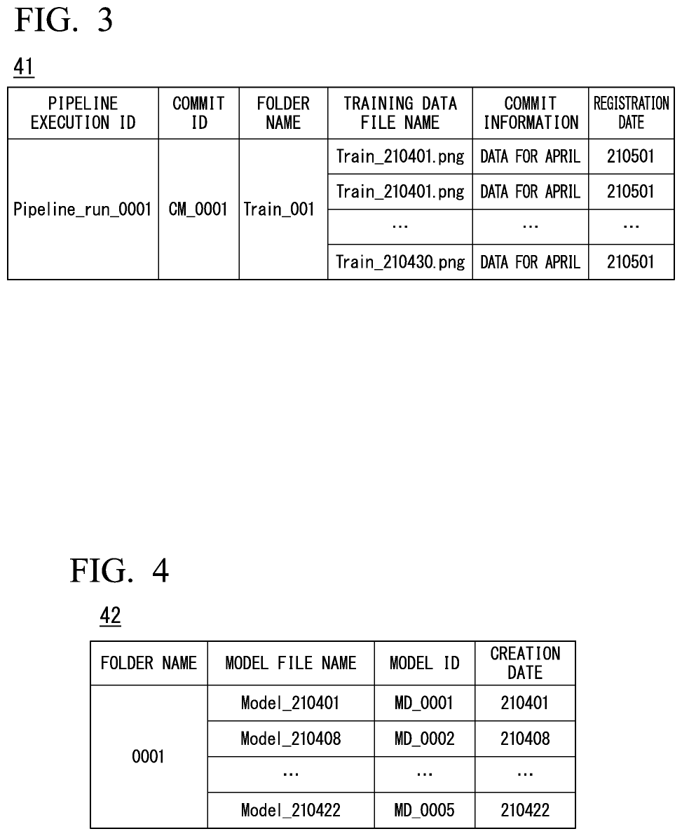

FIG. 3 is a diagram showing an example of a data configuration of the training data storage 41 according to the embodiment. The training data storage 41 stores information such as a pipeline execution ID, a commit ID, a folder name, a training data file name, commit information, and a registration date. The pipeline execution ID is an identifier for identifying the execution of the machine learning pipeline (MLP). The pipeline execution ID is issued by the management device 1 (for example, the controller 10) every time the machine learning pipeline (MLP) is executed. The commit ID is an identifier for identifying the saving of data in the training data storage 41. The commit ID is issued by the management device 1 (for example, the controller 10, the management program of the training data storage 41, or the like) every time the data is saved in the training data storage 41. The folder name is a name of a saving location within the training data storage 41. The training data file name is a file name of the training data. The commit information is information related to the saving of data in the training data storage 41. The registration date is a date on which the training data was registered.

FIG. 4 is a diagram showing an example of the data configuration of the model storage 42 according to the embodiment. The model storage 42 stores information such as a folder name, a model file name, a model ID, and a creation date. The folder name is a name of a storage location within the model storage 42. The model file name is a file name of the model. The creation date is a date when the model was created.

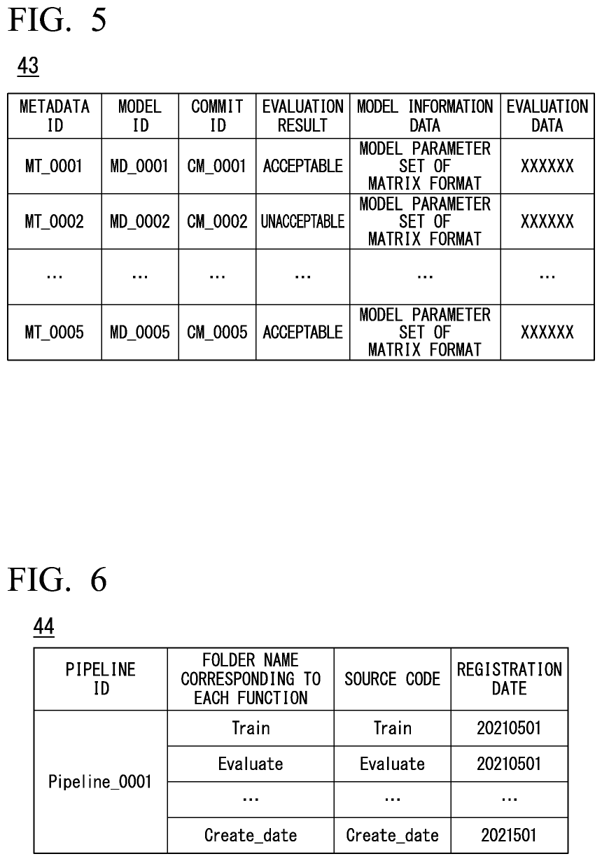

FIG. 5 is a diagram showing an example of a data configuration of the metadata storage 43 according to the embodiment. The metadata storage 43 stores information such as a metadata ID, a model ID, a commit ID, an evaluation result, model information data, and evaluation data. The metadata ID is an identifier for identifying the metadata. The evaluation result is a model evaluation result of the evaluator 14. Model information data is information that describes the model. The evaluation data is information indicating the evaluation data used for an evaluation process of the evaluator 14.

FIG. 6 is a diagram showing an example of a data configuration of the source code storage 44 according to the embodiment. The source code storage 44 stores information such as a folder name, a source code, and a registration date corresponding to each function. The folder name corresponding to each function is a name of a storage location within the source code storage 44. The source code is a program that implements each function. The registration date is a date when the source code was registered.

### [Workflow of Version Management Process]

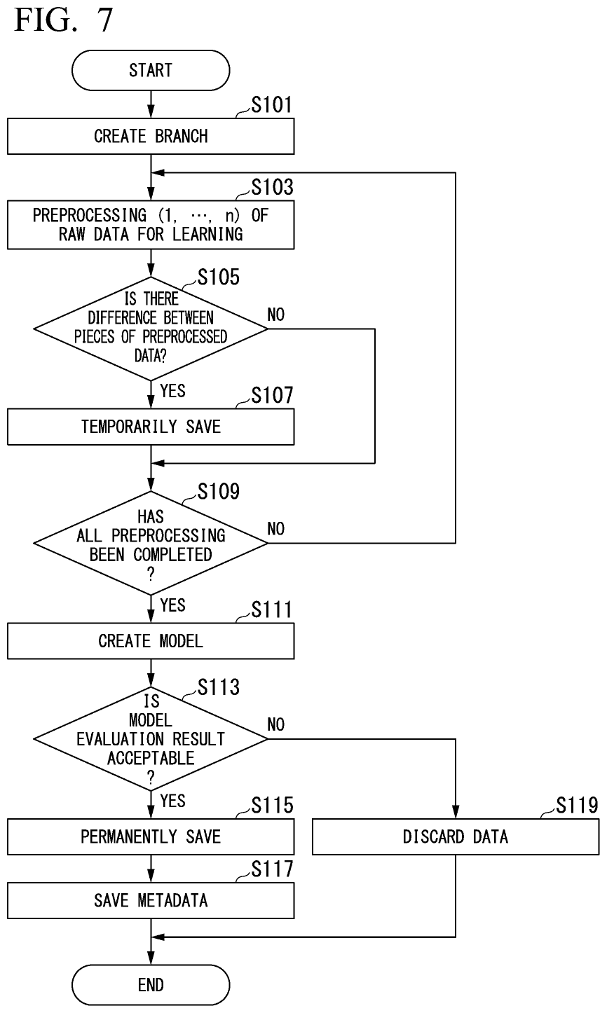

Hereinafter, an overall flow (workflow) of the version management process of the management device 1 will be described. FIG. 7 is a flowchart showing an example of the workflow of the version management process of the management device 1 according to the embodiment. The management device 1 manages versions of various types of data by executing a workflow preset on the machine learning pipeline. The flowchart shown in FIG. 7 is executed on the basis of, for example, a workflow execution instruction from the model developer via the input interface 20. In the flowchart shown in FIG. 7, a case where there is a plurality of pieces of preprocessing (1, . . . , n) will be described as an example.

First, the data manager 151 creates a branch (step S101). The branch is a function for branching a model development process on a machine learning pipeline. Because the branched branch does not affect the created model, it is possible to create a new model while keeping the created model. For example, the data manager 151 uses a pipeline execution ID as a name of the branch.

Subsequently, the data processor 12 performs preprocessing on raw data for learning acquired by the raw data acquirer 112 (step S103). At the time of the initial execution of step S103, the data processor 12 performs first pre-processing (1) among a plurality of pieces of pre-processing (1, . . . , n).

Subsequently, the data manager 151 compares the latest preprocessed data of step S103 with preprocessed data of step 5103 of a previous process (preprocessed data temporarily stored in the training data storage 41) and determines whether or not there is a difference between two pieces of preprocessed data (step S105). At the time of the initial execution of step S105, it is determined that there is a difference because there is no previous preprocessed data. When the data manager 151 determines that there is a difference between the two pieces of preprocessed data (step S105; YES), the data manager 151 temporarily saves the latest preprocessed data in the training data storage 41 (step S107). On the other hand, when the data manager 151 determines that there is no difference between the two pieces of preprocessed data (step S105; NO), the latest preprocessed data is not temporarily saved. A state in which there is no difference between the two pieces of preprocessed data is, for example, a case where the data is not changed in the latest preprocessing of step S103 or the like.

Subsequently, the data processor 12 determines whether or not all the preprocessing has been completed (step S109). When the data processor 12 determines that all the preprocessing has not been completed (step S109; NO), the data processor 12 returns to step S103, performs uncompleted preprocessing on the latest preprocessed data, and iterates a subsequent process.

On the other hand, when it is determined that the data processor 12 has completed all the preprocessing (step 5109; YES), the learner 13 creates a model using the preprocessed data for which all the preprocessing has been completed as training data (step S111).

Subsequently, the evaluator 14 evaluates the created model and determines whether or not the model is acceptable (step S113). When the evaluator 14 determines that the model is acceptable (step S113; YES), the data manager 151 permanently saves a changed part of the latest preprocessed data for which all the preprocessing has been completed in the training data storage 41 (step S115). Subsequently, the metadata manager 153 saves a commit ID indicating a storage location of the training data issued at the time of permanent saving as metadata in the metadata storage 43 (step S117). Also, the model manager 152 saves the created model in the model storage 42.

On the other hand, when the evaluator 14 determines that the model is unacceptable (step S113; NO), the data manager 151 discards the latest preprocessed data for which all the preprocessing has been completed (step S119). Also, the data manager 151 deletes the preprocessed data temporarily saved in the training data storage 41. Thereby, the process of the present flowchart is completed.

The component CP1 of the machine learning pipeline (MLP) shown in FIG. 2 has a function of performing the processing of step S101 described above. The component CP2 has a function of performing the processing of step S103 described above. The component CP3 has a function of performing the processing of steps S105 and S107 described above. The component CP4 has a function of performing the processing of step S111 described above. The component CP5 has a function of performing the processing of step S113 described above. The component CP6 has a function of performing the processing of step S115 described above. The component CP7 has a function of performing the processing of step S117 described above.

For example, when the training data temporarily saved in the branch merges into main training data saved in a main repository of Git managed for each machine learning pipeline, only difference data between the main training data and the training data that is temporarily saved (or temporarily deleted) is merged newly. After the training data merges into the main training data, redundant training data is eliminated from training data existing within a repository managed for each machine learning pipeline by deleting the training data temporarily saved (or temporarily deleted) in the branch and redundancy can be excluded. Furthermore, in the present embodiment, both the temporary deletion and the permanent deletion are physically deleting various types of data from the storage 41. The temporary deletion is temporarily (provisionally) deleting data from the storage 41 before a final deletion decision is made. The permanent deletion is deleting the data from the storage 41 after the final deletion decision is made (changing the temporarily deleted data to the permanently deleted state and completely erasing the data).

A case where a repository name of Git of a location where the training data is saved is set as a pipeline ID, which is an identifier of the machine learning pipeline, will be described as an example. A pipeline execution ID, which is an execution identifier of the machine learning pipeline, is created as a branch name of Git for training data version management. The pipeline execution ID becomes an identical pipeline execution ID when the preprocessing fails and the workflow of the present embodiment is re-executed. It is possible to uniquely define which machine learning pipeline the training data is used in through the pipeline execution ID. When the training data has already been permanently saved in the repository, it is determined whether there is a difference between the training data permanently saved in the repository and the preprocessed data to be permanently saved used when a new model has been created in the machine learning pipeline. When there is a difference, difference data is temporarily saved in the branch whose branch name is designated as the pipeline execution ID. The difference data is a group of difference data between the preprocessed data that has already been temporarily saved and the preprocessed data that is about to be temporarily saved therefrom.

When the preprocessed data that has been partially deleted from the training data that has already been permanently saved is a difference location, the difference data that has been partially deleted from the training data is temporarily saved. After the created model is evaluated by the evaluator, a difference in the training data used for training is permanently saved when the evaluation result is acceptable. When the evaluation result is unacceptable, the branch that is difference information of the training data that has been temporarily saved is discarded. Temporary deletion of training data is performed, permanent deletion is performed with respect to a difference of deleted training data when the evaluation result is acceptable, and the branch of training data that has been temporarily deleted is deleted when the evaluation result is unacceptable. When permanent saving (or permanent deletion) has been performed, the commit ID, which is an identifier of the saving location, is saved as metadata in the metadata storage 43.

### [Workflow for Adding Version Management Function to Machine Learning Pipeline]

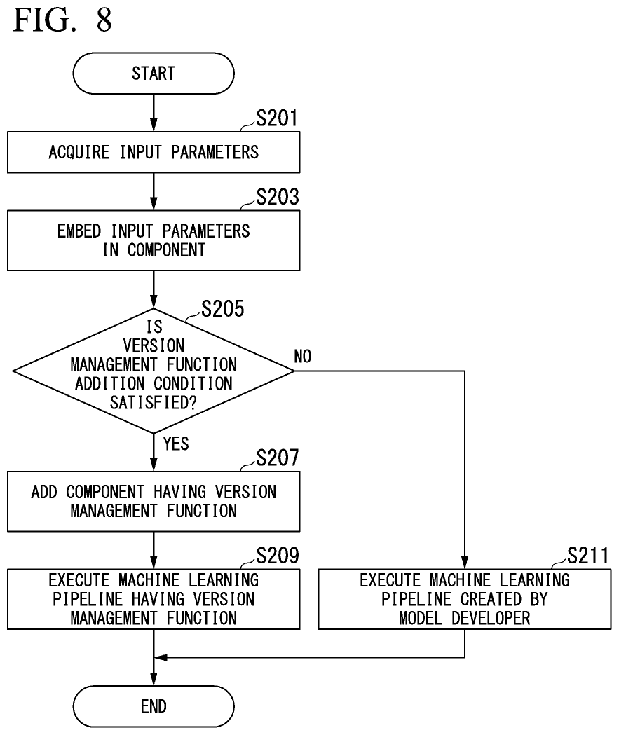

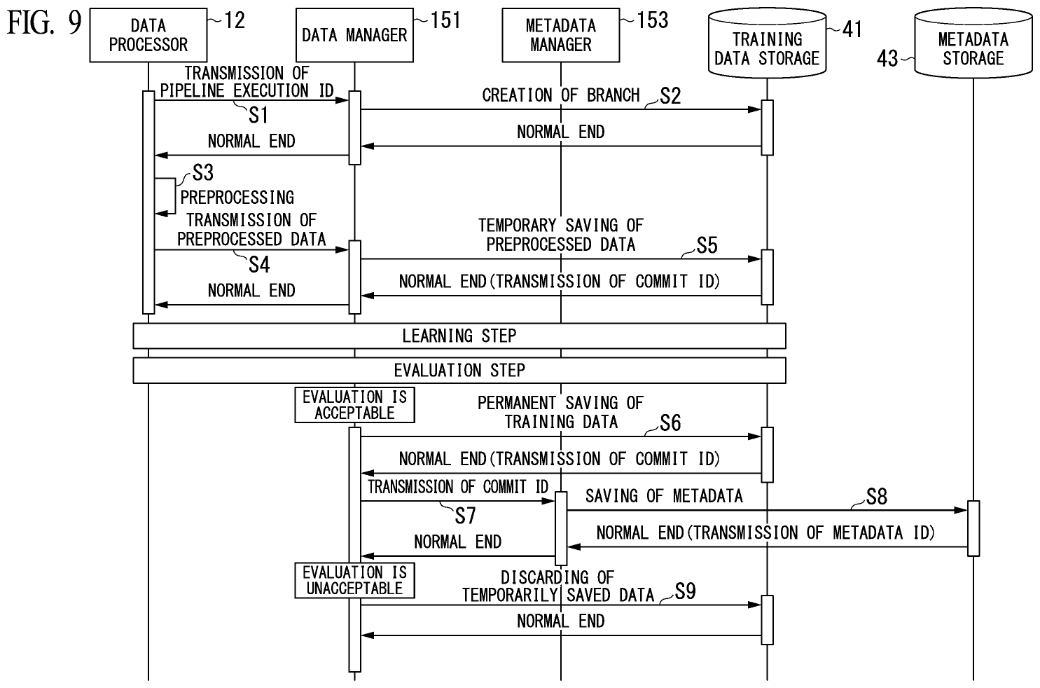

Next, a workflow for adding a component with a data version management function to the machine learning pipeline created in advance by the model developer will be described. FIG. 8 is a flowchart showing an example of a workflow of a version management function addition process of the management device 1 according to the embodiment.

First, the parameter acquirer 111 acquires input parameters (access destination information and authentication information of a training data version management tool) input by the model developer via the input interface 20 (step S201).

Subsequently, the data manager 151 embeds the acquired input parameters in the component that manages a version of data (step S203). Thereby, the creation of the component that manages the version of the data is completed.

Subsequently, the data manager 151 determines whether or not the machine learning pipeline created by the model developer satisfies a condition for adding the version management function (step S205). For example, the data manager 151 determines whether or not a parameter argument of the component included in the machine learning pipeline created by the model developer has a predetermined format. This parameter argument is set to use data version management. When the use of version management is desired, the model developer sets the parameter argument according to a predetermined rule in the machine learning pipeline. On the other hand, the model developer does not set this parameter argument when the use of version management is not desired.

For example, a condition that the name of the parameter argument related to the training data of the component of the machine learning pipeline is a predetermined name (for example, “training_commit_data”) is defined as a condition for adding the version management function. When the name of the parameter argument according to this condition exists in the component created by the model developer, a component with the data version management function of the training data before the learning component is added and a new machine learning pipeline is created. Furthermore, although the parameter argument is used as a condition for adding the version management function in the present embodiment, the present invention is not limited to this and other rules may be used.

When the data manager 151 determines that the condition for adding the version management function is satisfied (step 5205; YES), the data manager 151 adds a component having a data version management function to the machine learning pipeline created by the model developer (step S207). Subsequently, the data manager 151 executes a machine learning pipeline having a version management function (step S209).

On the other hand, when it is determined that the condition for adding the version management function is not satisfied (step 5205; NO), the data manager 151 executes the machine learning pipeline created by the model developer without adding the component having the version management function (step S211). Thereby, the process of the present flowchart is completed.

### [Flow for Version Management of Training Data (Initial Time)]

Next, an initial operation when training data version management is performed will be described with reference to a sequence diagram (FIG. 9) showing the exchange of data between functional blocks of the management device 1. First, the data processor 12 transmits a pipeline execution ID to the data manager 151 (S1). Subsequently, the data manager 151 creates a branch for saving the training data under the name of the pipeline execution ID in the training data storage 41 (S2). Subsequently, the data processor 12 performs preprocessing for creating training data to be used for model creation (S3) and transmits preprocessed data to the data manager 151 (S4). The data manager 151 temporarily saves the preprocessed data in the branch created in the training data storage 41 (S5).

Subsequently, after model creation (a learning step) of the learner 13 and model evaluation (an evaluation step) of the evaluator 14 are performed, when the model evaluation of the evaluator 14 is acceptable, the data manager 151 transmits a permanent saving command with respect to the preprocessed data temporarily saved in the training data storage 41, whereby the preprocessed data is permanently saved in the training data storage 41 (S6). When the permanent saving process ends normally, the data manager 151 transmits a commit ID received from the training data storage 41 to the metadata manager 153 (S7). The metadata manager 153 saves the received commit ID as metadata together with model information (hyperparameters and the like) in the metadata storage 43 (S8). On the other hand, when the model evaluation of the evaluator 14 is unacceptable, the data manager 151 transmits a command for discarding the temporarily saved preprocessed data to the training data storage 41 (S9). Thereby, the preprocessed data temporarily saved in the metadata storage 43 is discarded.

### [Flow for Performing Training Data Version Management (Addition of Difference Data)]

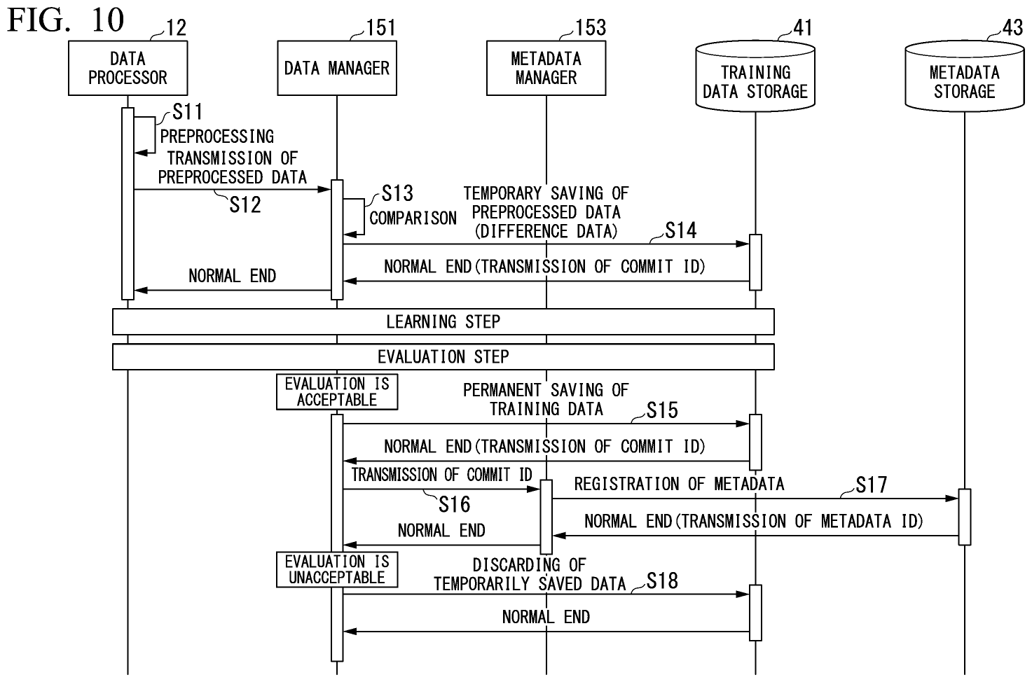

Next, an operation of adding the difference data when the training data version management is performed will be described with reference to a sequence diagram (FIG. 10) showing the exchange of data between the functional blocks of the management device 1. First, the data processor 12 performs preprocessing for creating training data to be used for model creation (S11) and transmits preprocessed data and a pipeline execution ID to the data manager 151 (S12). Subsequently, the data manager 151 acquires past training data stored in the training data storage 41, compares new preprocessed data transmitted from the data processor 12 with the past training data, and determines whether or not there is a difference between the past training data and the new preprocessed data (S13). Here, because there is difference data (the new preprocessed data includes new data that does not exist in the past training data), the data manager 151 temporarily saves the difference data in the branch created in the training data storage 41 (S14).

Subsequently, after model creation (a learning step) of the learner 13 and model evaluation (an evaluation step) of the evaluator 14 are performed, when the model 10 evaluation of the evaluator 14 is acceptable, the data manager 151 transmits a permanent saving command with respect to the preprocessed data (difference data) temporarily saved in the training data storage 41, whereby the preprocessed data (difference data) is permanently saved in the training data storage 41 (S15). When the permanent saving process has ended normally, the data manager 151 transmits a commit ID received from the training data storage 41 to the metadata manager 153 (S16). The metadata manager 153 registers the received commit ID as metadata together with model information (hyperparameters and the like) in the metadata storage 43 (S17). On the other hand, when the model evaluation of the evaluator 14 is unacceptable, the data manager 151 transmits a command for discarding the temporarily saved preprocessed data (difference data) to the training data storage 41 (S18). Thereby, the preprocessed data (difference data) temporarily saved in the metadata storage 43 is discarded.

### [Flow for Performing Training Data Version Management (Deletion of Difference Data)]

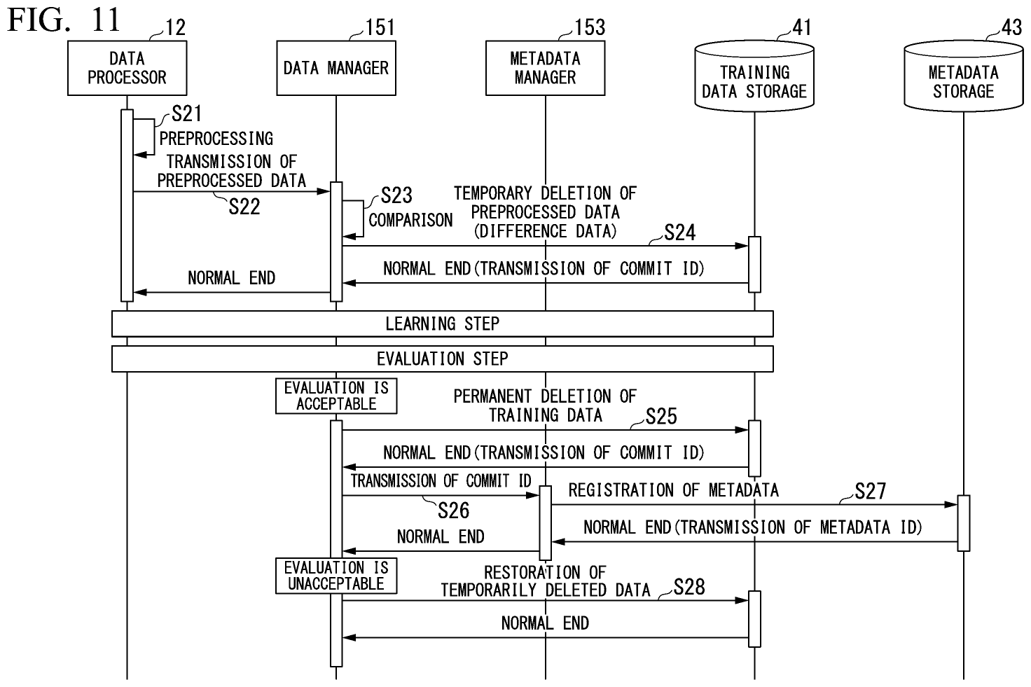

Next, an operation of deleting the difference data when the training data version management is performed will be described with reference to a sequence diagram (FIG. 11) showing the exchange of data between the functional blocks of the management device 1. First, the data processor 12 performs preprocessing for creating training data to be used for model creation (S21) and transmits preprocessed data and a pipeline execution ID to the data manager 151 (S22). Subsequently, the data manager 151 acquires past training data stored in the training data storage 41, compares new preprocessed data transmitted from the data processor 12 with the past training data, and determines whether or not there is a difference between the past training data and the new preprocessed data (S23). Here, because there is difference data (at least a part of the past training data is deleted in the new preprocessed data), the data manager 151 temporarily deletes difference data from the branch created in the training data storage 41 (S24).

Subsequently, after model creation (a learning step) of the learner 13 and model evaluation (an evaluation step) of the evaluator 14 are performed, when the model evaluation of the evaluator 14 is acceptable, the data manager 151 transmits a permanent deletion command with respect to the preprocessed data (difference data) temporarily saved in the training data storage 41, whereby the preprocessed data (difference data) is permanently deleted from the training data storage 41 (S25). When the permanent deletion has ended normally, the data manager 151 transmits a commit ID received from the training data storage 41 to the metadata manager 153 (S26). The metadata manager 153 registers the received commit ID as metadata together with model information (hyperparameters and the like) in the metadata storage 43 (S27). On the other hand, when the model evaluation of the evaluator 14 is unacceptable, the data manager 151 transmits a command for restoring the temporarily deleted preprocessed data (difference data) to the training data storage 41 (S28). Thereby, the preprocessed data (difference data) temporarily deleted in the metadata storage 43 is restored.

### [Flow of Comparison Process in Training Data Version Management]

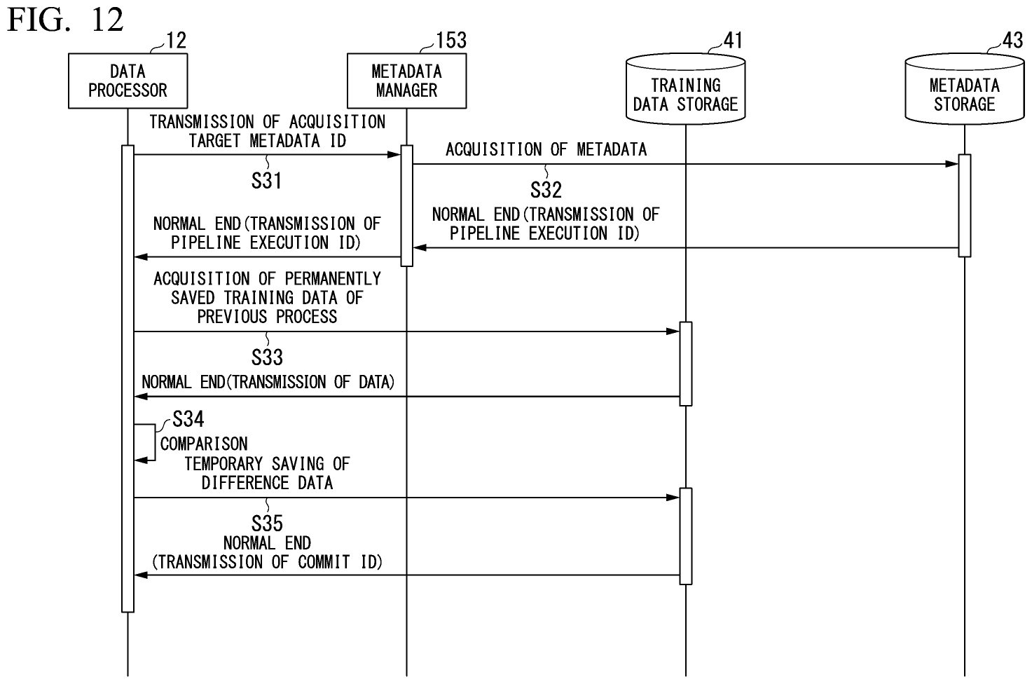

Next, the operation of the comparison process when the training data version management is performed will be described with reference to a sequence diagram (FIG. 12) showing the exchange of data between the functional blocks of the management device 1. First, the data manager 151 transmits a metadata ID to the metadata manager 153 such that a pipeline execution ID for identifying the branch in which past training data is saved is acquired (S31). The metadata manager 153 acquires a pipeline execution ID corresponding to the metadata ID received from the metadata storage 43 (S32) and transmits the acquired pipeline execution ID to the data manager 151. The data manager 151 acquires past training data (previously permanently saved training data) from the training data storage 41 on the basis of the acquired pipeline execution ID (S33).

Subsequently, the data manager 151 compares the acquired past training data with the preprocessed training data newly acquired from the data processor 12 and determines whether or not there is a difference between the past training data and the preprocessed training data (S34). When there is difference data, the data manager 151 creates a branch using the acquired pipeline execution ID as the branch name and temporarily saves the branch in the training data storage 41 (S35). Thereby, the data manager 151 acquires a commit ID indicating a location where the difference data is temporarily saved from the training data storage 41.

### [Flow of Model Management Process in Training Data Version Management]

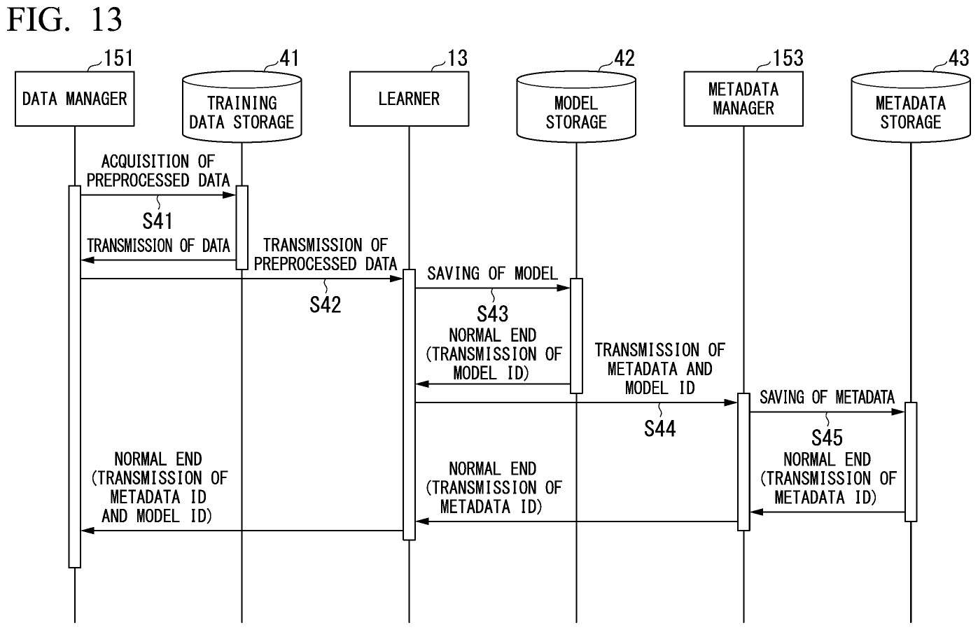

Next, the operation of the model management process when the training data version management is performed will be described with reference to a sequence diagram (FIG. 13) showing the exchange of data between the functional blocks of the management device 1. First, the data manager 151 acquires the preprocessed data temporarily saved in the branch created in the training data storage 41 (S41). Subsequently, the data manager 151 transmits the acquired preprocessed data to the learner 13 (S42).

The learner 13 saves a model created by learning the preprocessed data received from the data manager 151 in the model storage 42 (S43). Here, the learner 13 saves a model having an acceptable evaluation result of the evaluator 14 in the model storage 42.

When the saving has ended normally, the learner 13 acquires the model ID from the model storage 42. Subsequently, the learner 13 transmits the metadata (hyperparameters and the like) and the model ID used at the time of model creation to the metadata manager 153 (S44).

Subsequently, the metadata manager 153 saves the metadata received from the learner 13 in the metadata storage 43 (S45). When the saving of the metadata has ended normally, the metadata manager 153 acquires the metadata ID from the metadata storage 43 and transmits the acquired metadata ID to the learner 13. The learner 13 transmits the metadata ID and the model ID to the data manager 151.

### [Flow of Model Evaluation Process in Training Data Version Management]

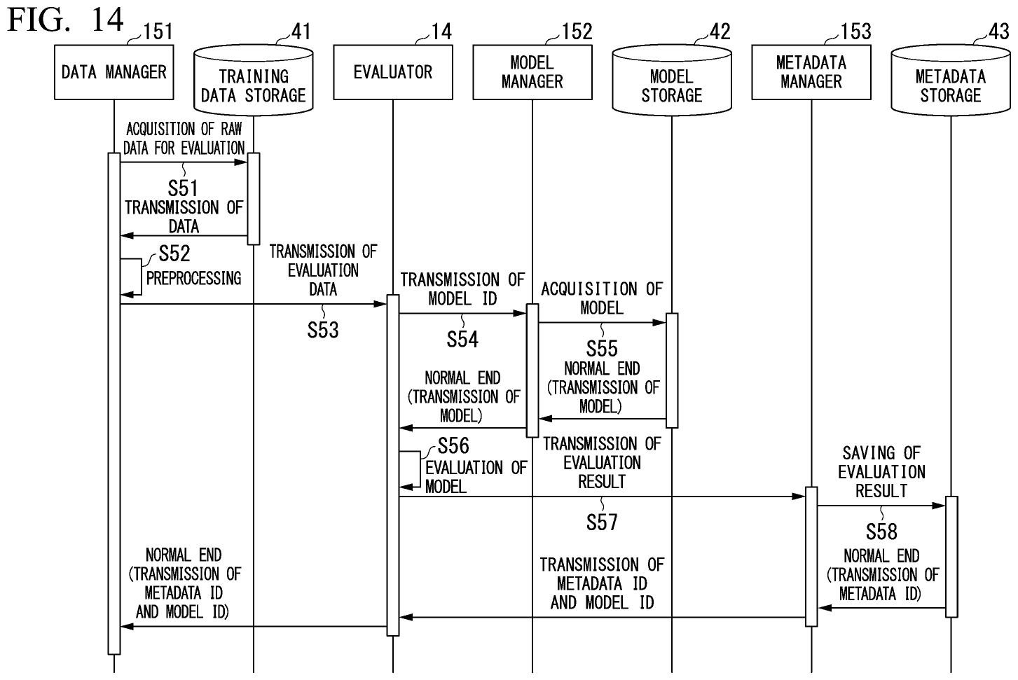

Next, the operation of the model evaluation process when training data version management is performed will be described with reference to a sequence diagram (FIG. 14) showing the exchange of data between the functional blocks of the management device 1. First, the data manager 151 acquires raw data for evaluation saved in the training data storage 41 (S51). Subsequently, the data manager 151 performs preprocessing on the acquired raw data for evaluation (S52) and transmits the preprocessed data as evaluation data to the evaluator 14 (S53).

Subsequently, the evaluator 14 transmits a model ID of an evaluation target model to the model manager 152 (S54). The model manager 152 acquires a model corresponding to the model ID received from the evaluator 14 from the model storage 42 (S55) and transmits the acquired model to the evaluator 14. The evaluator 14 evaluates the model using the model received from the model manager 152 and the evaluation data received from the data manager 151 (S56). The evaluator 14 transmits an evaluation result to the metadata manager 153 (S57). The metadata manager 153 saves the evaluation result received from the evaluator 14 in the metadata storage 43 (S58).

When the saving of the evaluation result (metadata) has ended normally, the metadata manager 153 acquires a metadata ID from the metadata storage 43 and transmits the acquired metadata ID to the evaluator 14 together with a model ID. The learner 13 transmits the metadata ID and the model ID to the data manager 151. Furthermore, although the model whose evaluation result is unacceptable is deleted from the model storage 42, the metadata (the evaluation result) may be left. For example, non-acceptance information may be saved in the metadata (the evaluation result).

### [Flow for Automatically Adding Component for Performing Training Data Version Management]

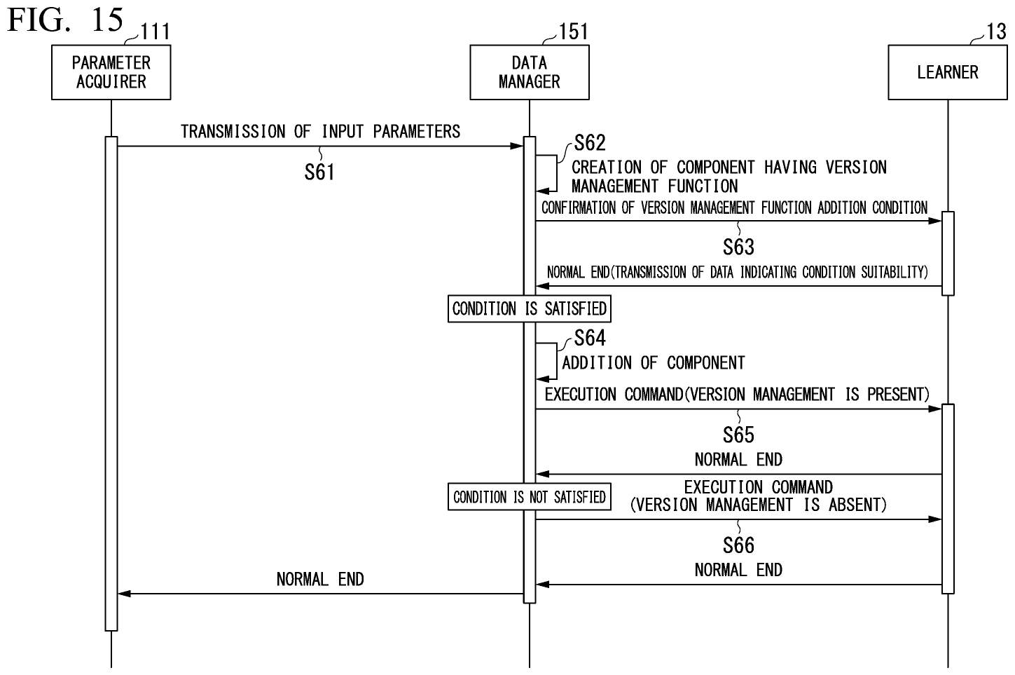

Next, an operation of automatically adding a component for performing training data version management will be described with reference to a sequence diagram (FIG. 15) showing the exchange of data between the functional blocks of the management device 1. First, the parameter acquirer 111 acquires input parameters (a training data saving destination, authentication information of a saving tool, and the like) input by the model developer and transmits the input parameters to the data manager 151 (S61). The authentication information includes, for example, an IP address and a user name of the saving tool, a password (an access key of secret key), and the like. Subsequently, the data manager 151 creates a component having a function similar to that of a source code for training data version management using the authentication information received from the parameter acquirer 111 (S62). For example, the data manager 151 embeds the authentication information in a component having a version management function.

Next, the data manager 151 acquires information necessary for deciding where the created component will be added in the machine learning pipeline created in advance by the model developer from the learner 13. Specifically, the name of the input parameter related to the training data of the component having a learning function is acquired. The data manager 151 determines whether or not an argument name of a parameter argument of the training data, which is one of the input parameters of the component having the learning function, is a predetermined argument name (whether or not a version management function addition condition is satisfied) (S63). For example, the argument name is predefined as “training_commit_data,” and it is determined whether or not the argument name of the training data of the component having the learning function created in advance by the model developer is “training_commit_data.” When the argument name of the parameter argument matches the predetermined argument name, the data manager 151 adds the component having a training data version management function before the component having the learning function created by the model developer and creates a machine learning pipeline (S64). Next, the data manager 151 executes the created machine learning pipeline having a version management function (S65). On the other hand, when the argument name of the parameter argument does not match the predetermined argument name, the data manager 151 executes a machine learning pipeline created by the model developer as it is without adding a component having a training data version management function (S66).

According to the management device 1 of the embodiment configured as described above, efficient training data version management can be implemented by implementing the training data version management in combination with the machine learning pipeline. Also, it is possible to confirm the metadata and training data that are the basis for the exclusion of redundancy of training data and comparison between models created in the machine learning pipeline. When training data version management is performed, a function of temporarily saving the preprocessed data every time raw data for learning is preprocessed is provided, such that, even if there is a failure while the machine learning pipeline is being executed, a process up to preprocessing in which temporary saving has been performed can be omitted and a period of time required for a process of preprocessing training data can be reduced. Also, it is unnecessary to program a code for training data version management by implementing the same function in the component of the machine learning pipeline without creating a source code that describes the processing content for implementing version management with respect to training data and it is possible to save time and eliminate a coding error in model development.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management device comprising:
a data processor configured to perform at least one preprocessing operation of creating a training dataset;
a data manager configured to perform a process of saving the created training dataset; and
an evaluator configured to evaluate a model created using the created training dataset,
wherein the data manager is configured to:
temporarily save the created training dataset; and
determine whether or not to permanently save the created training dataset on the basis of an evaluation result of the model by the evaluator.

2. The management device according to claim 1, wherein the data manager is
configured to determine whether or not there is a difference between a training dataset newly created in a preprocessing operation by the data processor and the saved preprocessed training dataset.

3. The management device according to claim 1, wherein
the at least one preprocessing operation includes first preprocessing and second preprocessing,
the data processor is configured to create a second preprocessed dataset by performing the second preprocessing on the temporarily saved first preprocessed training dataset, and
the data manager is configured to temporarily save the second preprocessed dataset.

4. The management device according to claim 3, wherein the data manager is configured to determine whether or not there is a difference between the first preprocessed dataset and the second preprocessed dataset.

5. The management device according to claim 4, wherein the data manager is configured to temporarily save the second preprocessed dataset in a case where it is determined that there is a difference between the first preprocessed dataset and the second preprocessed dataset.

6. The management device according to claim 1, wherein the data manager is configured to determine to permanently save the created training dataset in a case where the evaluation result of the model is acceptable.

7. The management device according to claim 6, wherein the data manager is configured to determine not to permanently save the created training dataset in a case where the evaluation result of the model is unacceptable and discard the temporarily saved training dataset.

8. The management device according to claim 1, wherein the data manager is configured to create a branch for performing version management and temporarily save the created training dataset in the branch.

9. The management device according to claim 1, wherein the data manager is configured to temporarily save the created training dataset every time each of a plurality of preprocessing operations is completed.

10. The management device according to claim 1, wherein the data manager is configured to save metadata related to a training process of the model.

11. A management method comprising:
performing, by a computer, at least one preprocessing operation of creating a training dataset;
saving, by the computer, the created training dataset; and
evaluating, by the computer, a model created using the created training dataset, wherein
the saving of the created training dataset comprises:
temporarily saving the created training dataset; and
determining whether or not to permanently save the created training dataset on the basis of an evaluation result of the model.

12. A computer-readable non-transitory storage medium storing a program for causing a computer to:
perform at least one preprocessing operation of creating a training dataset;
save the created training dataset; and
evaluate a model created using the created training dataset,
wherein
the saving of the created training dataset comprises:
temporarily saving the created training dataset; and
determining whether or not to permanently save the created training dataset on the basis of an evaluation result of the model.
